(19) United States
(12) Patent Application Publication
(10) Pub. No.: US 2013/0170552 A1
(43) Pub. Date: Jul. 4, 2013

(54) APPARATUS AND METHOD FOR SCALABLE VIDEO CODING FOR REALISTIC BROADCASTING

(71) Applicants: Tae Jung KIM, Cheongju-si Chungcheongbuk-do (KR); Chang Ki KIM, Daejeon (KR); Jeong Ju YOO, Daejeon (KR); Young Ho JEONG, Daejeon (KR); Jin Woo HONG, Daejeon (KR); Kwang Soo HONG, Seoul (KR); Byung Gyu KIM, Cheonan-si Chungcheongnam-do (KR)

(72) Inventors: Tae Jung KIM, Cheongju-si Chungcheongbuk-do (KR); Chang Ki KIM, Daejeon (KR); Jeong Ju YOO, Daejeon (KR); Young Ho JEONG, Daejeon (KR); Jin Woo HONG, Daejeon (KR); Kwang Soo HONG, Seoul (KR); Byung Gyu KIM, Cheonan-si Chungcheongnam-do (KR)

(73) Assignees: Industry-University Cooperation Foundation Sunmoon University, Asan-si (KR); Electronics and Telecommunications Research Institute, Daejeon (KR)

(21) Appl. No.: 13/619,332

(22) Filed: Sep. 14, 2012

(30) Foreign Application Priority Data
Jan. 4, 2012 (KR) 10-2012-0001169

(51) Int. Cl. H04N 7/32

(52) U.S. Cl. 375/240.16; 375/E07.243; 375/E07.104

(57) ABSTRACT

A scalable video coding apparatus and method for realistic broadcasting are provided. The scalable video coding apparatus may include a spatial scalable coding unit to perform intra-view predictive coding in base layers of a color image and a depth image and prediction in enhancement layers by referencing motion information of the base layer, a signal-to-noise ratio (SNR) scalable coding unit to perform coding using quantization which is a method for SNR scalability of the color image, and a motion estimation device to code the base layer of the depth image using the motion information of the base layer of the color image as prediction data.

### CROSS-REFERENCE TO RELATED APPLICATION

This application claims the benefit of Korean Patent Application No. 10-2012-0001169, filed on Jan. 4, 2012, in the Korean Intellectual Property Office, the disclosure of which is incorporated herein by reference.

### BACKGROUND

1. Field of the Invention

The present invention relates to a scalable video coding apparatus and method for realistic broadcasting, capable of efficiently compressing a video signal for a realistic scalable service.

2. Description of the Related Art

Realistic multi-view scalable video coding is a method that supports various terminals and various transmission environments and, simultaneously, supports a realistic service as shown in FIG. 1. To support such various terminals, various transmission environments, and the realistic service, it is demanded to also support various views, various screen sizes, various image qualities, and various temporal resolution levels. A scalable video coding (SVC) method and a multi-view video coding (MVC) method are actually provided as the international standard related to development of the video coding technology.

The MVC method efficiently codes a plurality of views input from a plurality of cameras disposed at uniform intervals in various arrays. The MVC method supports realistic displays such as a 3-dimensional television (3DTV) or a free view-point TV (FTV).

FIG. 1 illustrates hierarchical B screen coding. Using the hierarchical B screen coding, coding efficiency is almost doubled compared to when respective views are independently coded simply by H.264/advanced video coding (AVC).

The SVC method integrally handles video information in various terminals and various transmission environments. The SVC generates integrated data supporting various spatial resolution levels, various frame rates, and various image qualities, so that data is efficiently transmitted to the various terminals in the various transmission environments.

According to the MVC method, when a plurality of cameras are used to obtain multi-view image content, a number of views is increased. However, a great bandwidth is required for transmission of the images. Furthermore, due to a limited number of cameras and interval between the cameras, discontinuity may be caused when a view is changed. Therefore, there is a demand for a method for synthesis of an intermediate view using a technology providing natural and continuous images while reducing data quantity.

For the intermediate view synthesis, a depth image is necessary. To apply a current 3DTV, multi-view video of a less number of views than a number of displayed views and multi-view video plus depth (MVD) data that uses a depth image corresponding to the multi-view video are obtained, coded, and transmitted. Therefore, a receiving end generates 3D video using an intermediate-view image.

However, in the present, such an integrated video coding method, capable of supporting the realistic service and also the various environments, is absent. Currently, user interest in the realistic content is rapidly increasing mainly with respect to a film industry. In addition, since user demands for the realistic content are also increasing, there will be an unavoidable need for a method of efficiently transmitting realistic video content to various terminals, such as a personal stereoscopic display and a multi-view image display, in various environments.

Therefore, to overcome the foregoing limits, the following embodiments introduce a realistic broadcasting scalable video coding method which efficiently codes MVD data using the MVC method and the SVC method to support various views, various image qualities, and various resolution levels for the realistic service in various terminals as shown in FIG. 2.

### SUMMARY

An aspect of the present invention provides a scalable video coding apparatus and method for realistic scalable broadcasting, which increase image quality and compression rate of a video encoder, by performing predictive coding with respect to multi-view video plus depth (MVD) data using a multi-view video coding (MVC) method and a scalable video coding (SVC) method and by predicting motion estimation performed for inter-prediction of a depth image using a motion vector generated and predicted through motion estimation performed for intra-prediction of a color image.

According to an aspect of the present invention, there is provided a scalable video coding apparatus including a spatial scalable coding unit to perform intra-view predictive coding in base layers of a color image and a depth image and prediction in enhancement layers by referencing motion information of the base layer, a signal-to-noise ratio (SNR) scalable coding unit to perform coding using quantization which is a method for SNR scalability of the color image, and a motion estimation device to code the base layer of the depth image using the motion information of the base layer of the color image as prediction data.

According to another aspect of the present invention, there is provided a scalable video coding method for realistic broadcasting, including performing intra-view predictive coding in base layers of a color image and a depth image and prediction in enhancement layers by referencing motion information of the base layer, using quantization as a method for signal-to-noise ratio (SNR) scalability of the color image, and coding a base layer of a depth image using motion information of the base layer of the color image as prediction data.

### EFFECT

According to embodiments of the present invention, a 3-dimensional (3D) or stereoscopic image of respective views may be achieved by considering compression of a depth image for generating an intermediate view image for realistic broadcasting while maintaining compatibility with conventional video coding technologies such as H.264/advanced video coding (AVC), scalable video coding (SVC), and multi-view video coding (MVC).

Additionally, according to embodiments of the present invention, a terminal including various types of display may support various screen sizes from video graphics array (VGA) resolution to full high definition (HD) resolution or higher resolution according to use and function.

Additionally, embodiments of the present invention are expected to be applied to a broadcasting service considering rapidly increasing interest of users in realistic content. In particular, the embodiments will be effectively applied to the 3D content industry such as a film industry.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating structure of multi-view video coding according to a related art;

FIG. 2 is a diagram illustrating an application scenario for a realistic service in various types of terminal according to a related art;

FIG. 3 is a diagram illustrating a multi-view image generation apparatus according to an embodiment of the present invention;

FIG. 4 is a diagram illustrating a multiview plus depth image video coding (MVDVC) apparatus according to an embodiment of the present invention;

FIGS. 5A, 5B, and 5C are diagrams illustrating a structure of an MVD data coding unit shown in FIG. 4;

FIGS. 6A and 6B are diagrams illustrating prediction structures for a spatial base layer and an improved layer of a color image and a depth image, according to an embodiment of the present invention; and

FIGS. 7A and 7B are diagrams illustrating a motion estimation prediction method of a depth image coding unit according to an embodiment of the present invention.

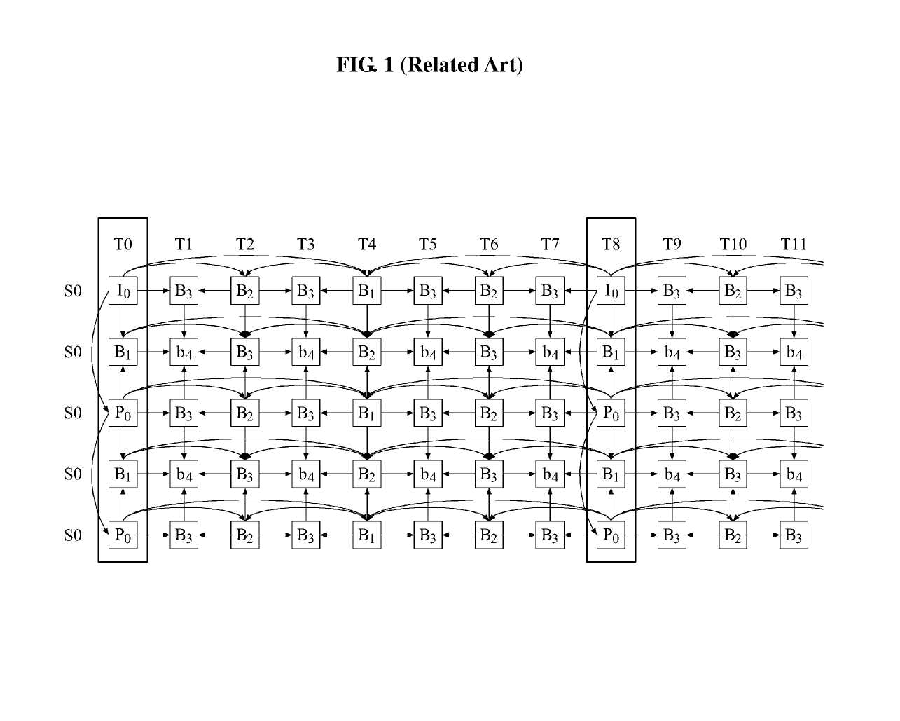

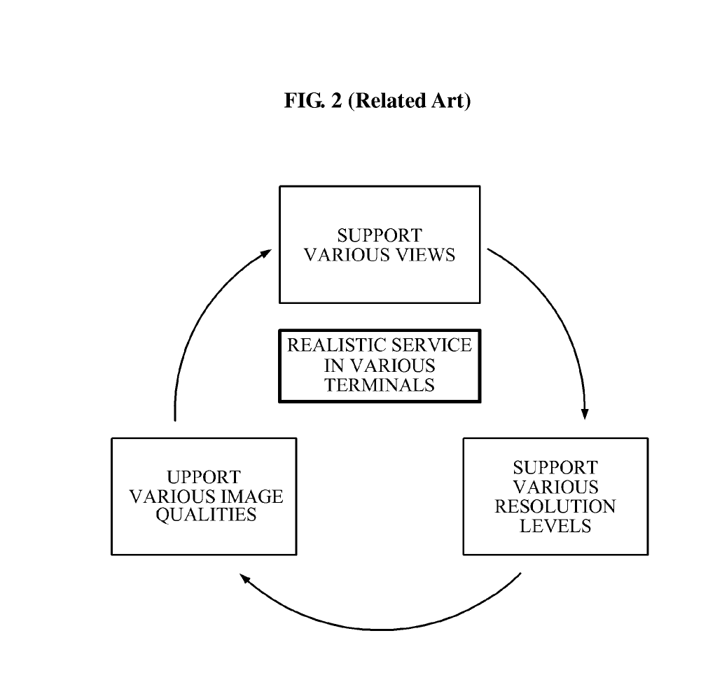

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

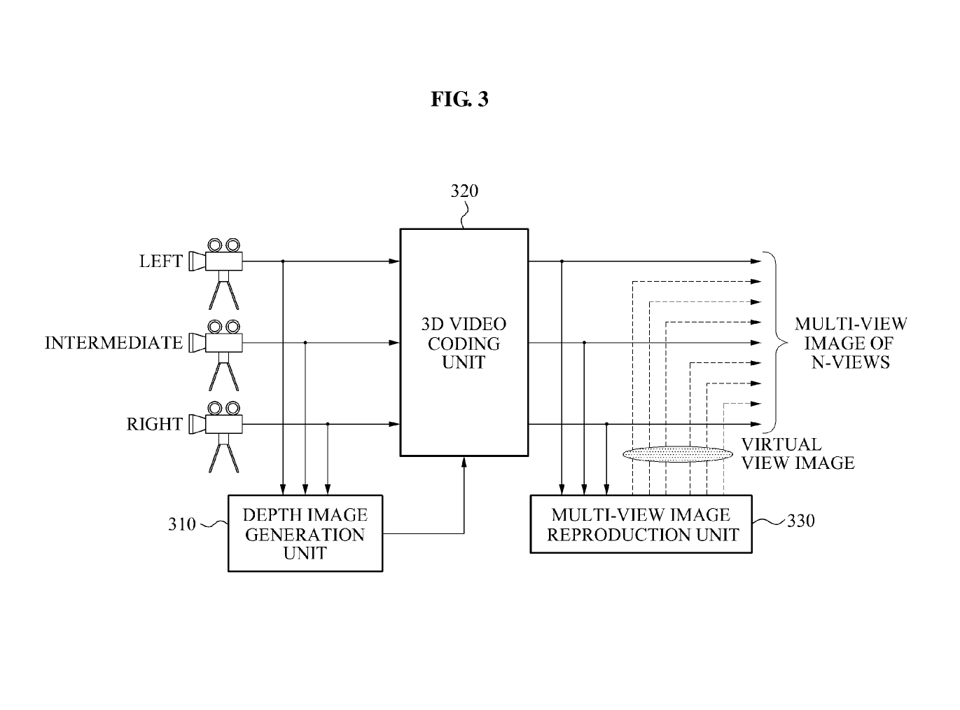

FIG. 3 illustrates a multi-view image generation apparatus according to an embodiment of the present invention. The multi-view image generation apparatus includes an image generation unit 310 to generate a depth image based on a multi-view color image, a 3-dimensional (3D) video coding unit 320 to code MVD data, and a multi-view image reproduction unit 330 to generate a random view using the MVD data.

The depth image generation unit 310 may generate depth images corresponding to respective views. The present moving picture expert group (MPEG) 3-dimensional video (3DV) group has developed depth estimation reference software (DERS), thereby enabling a depth image to be obtained. The 3D video coding unit 320 may code a depth image corresponding to a view of a color image. In a general 3D reproduction apparatus, the multi-view image reproduction unit 330 needs an image of more views than transmitted views. Therefore, a random view image synthesis technology using a depth image may be used. Usually, a technology called depth image based rendering (DIBR) is used to obtain an image of a random view. The MPEG 3DV group has developed view synthesis reference software (VSRS) based on the DIBR technology.

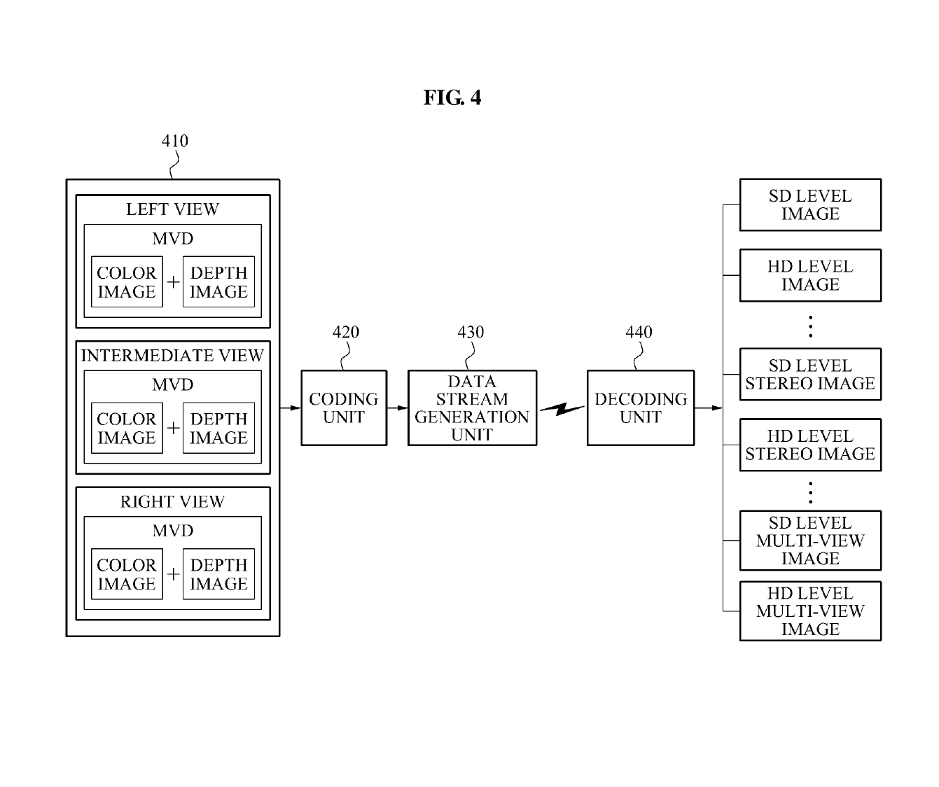

FIG. 4 is a diagram illustrating an operational structure of a multiview plus depth image video coding (MVDVC) apparatus according to an embodiment of the present invention.

The MVDVC apparatus may include an MVD data coding unit 420, a data stream generation unit 430, and an MVD data decoding unit 440.

The MVD data coding unit 420 performs video coding with respect to color images of three views corresponding to content 410 of MVD images and depth images corresponding to the three views. A data stream is generated by the data stream generation unit 430. The data stream is coded and transmitted. The MVD data decoding unit 440 may perform decoding using an MVDVC decoder or a multi-view video coding decoder so that an image is appreciated. To appreciate a single image of a high definition (HD) image quality, an H.264/advanced video coding (AVC) decoder or a scalable video coding decoder may be used. To appreciate a single image of a standard definition (SD) image quality, an MVCVD decoder may be used. To appreciate a stereoscopic image and multi-view image of the HD image quality, the MVCVD decoder or the multi-view video coding decoder may be used.

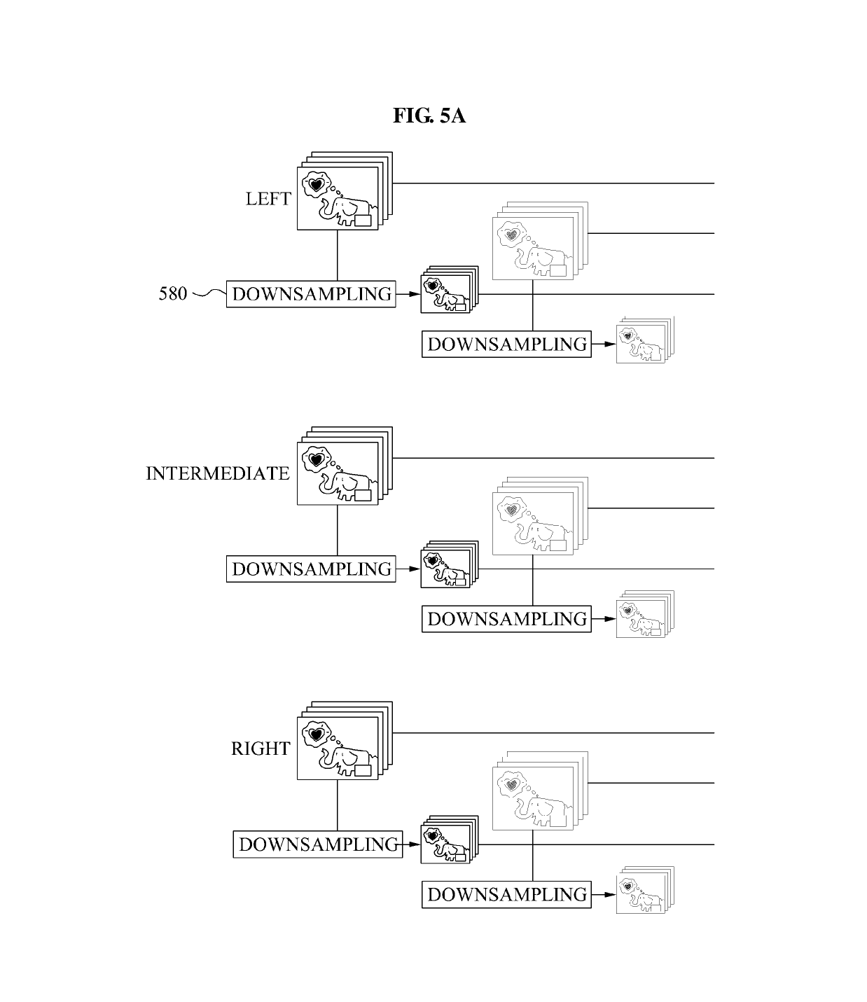

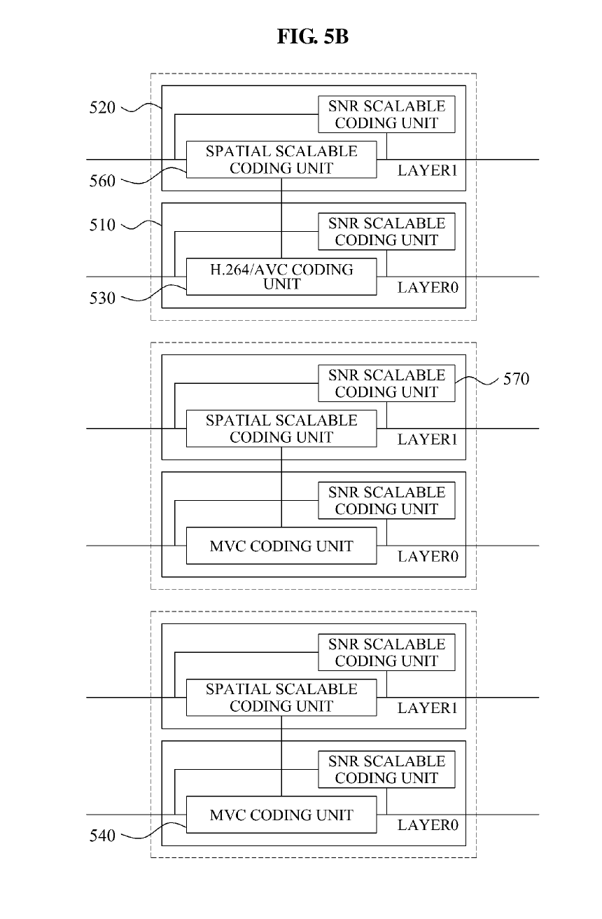

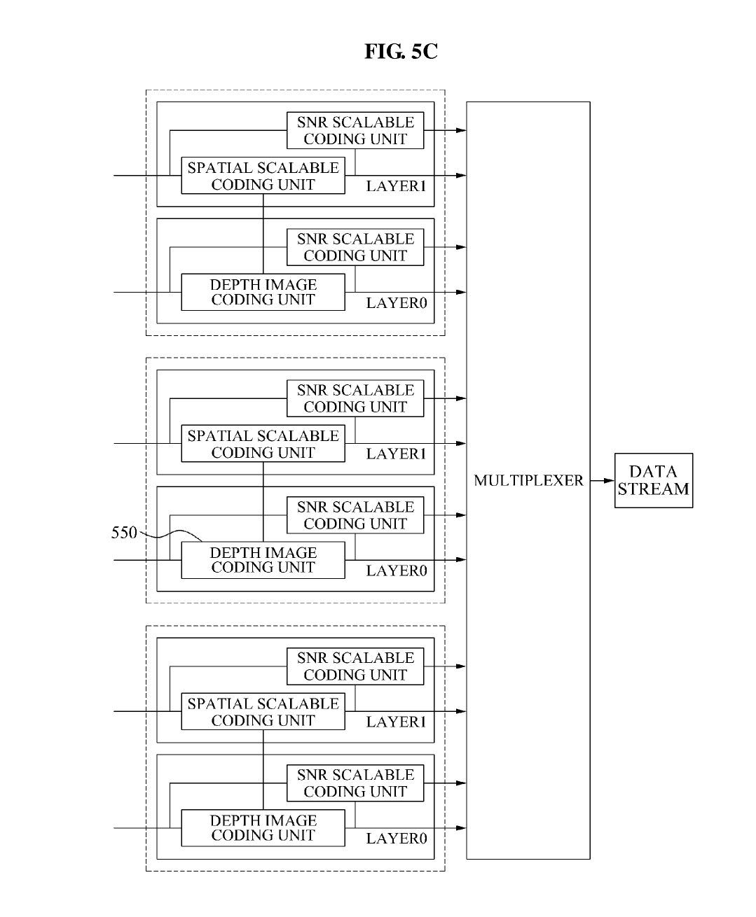

FIGS. 5A, 5B, and 5C are diagrams illustrating a detailed structure of the MVD data coding unit 420 of the MVDVC apparatus according to the embodiment of the present invention.

The MVD data coding unit 420 may include a base layer 510 and an enhancement layer 520 for scalable coding of MVD data of each view. Also, the MVD data coding unit 420 may further include an H.264/AVC video coding unit 530 and a multi-view video coding unit 540 for compatible use with a basic codec. In addition, the MVD data coding unit 420 may further include a depth image coding unit 550 to code a depth image for realistic broadcasting, and a spatial scalable coding unit 560 and a signal-to-noise ratio (SNR) scalable coding unit 570 provided to each layer to enable a service in various terminals.

The MVD data coding unit 420 may perform downsampling 580 with respect to the MVD data, that is, the color images and the depth images input from the three views, according to resolution of the base layer 510. Next, the MVD data may be input to an encoder of each enhancement layer 520.

The H.264/AVC video coding unit 530 refers to a device to provide a single image service for compatible use with the H.264/AVC applied in various fields as an image compression standard.

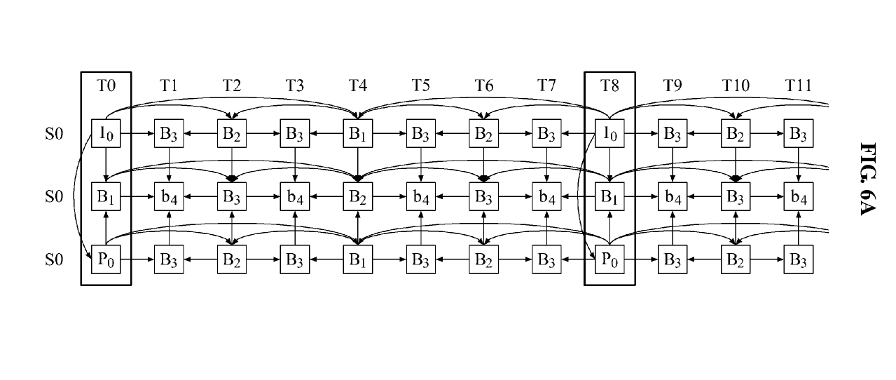

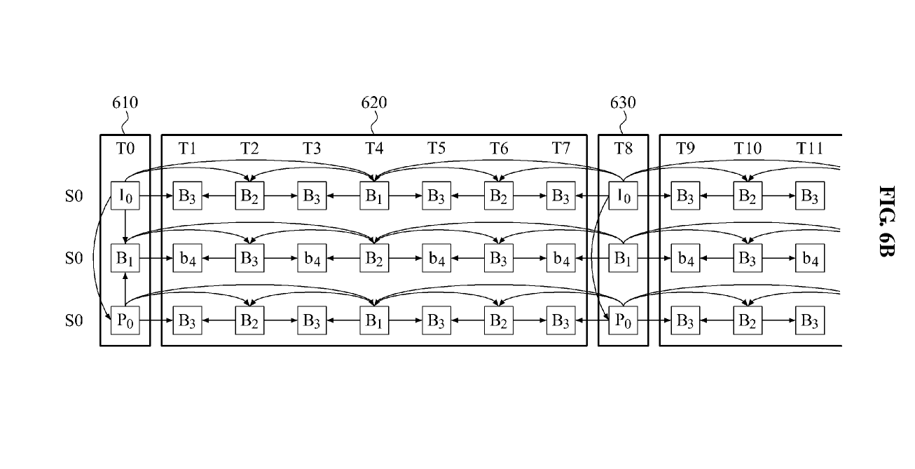

The multi-view video coding unit 540 refers to a device for compatible use with multi-view video coding which is a next-generation compression technology capable of providing a 3D image service through a 3D display. The multi-view video coding unit 540 may have identical prediction structures in each layer with respect to the color image, as shown in FIG. 6A. Generally, the spatial scalable coding unit 560 performs coding by predicting motion information according to a prediction structure of the base layer 510 and residual data information predicted using the motion information, rather than by predicting texture information by decoding all of the base layers 510. That is, the spatial scalable coding unit 560 performs coding according to the coding structure of the base layer 510 of scalable video coding, which is the reason that the respective layers have the identical prediction structures. However, when the multi-view video coding unit 540 has an inter-view predictive coding structure as shown in FIG. 6A, random access performance in the enhancement layer 520 at the same view may be reduced.

To overcome the reduced random access performance, an inter-view prediction structure is set for each layer only in anchor frames 610 and 630 as shown in FIG. 6B while an intra-view prediction structure is set for each layer in a non-anchor frame 620. Using the motion information, the texture information, the residual information and the like of the base layer 510, the random access performance may be increased. Also, this method is applicable to realistic application fields.

Therefore, intra-view predictive coding in the base layer 510 of the color images and intra-view predictive coding in the enhancement layer 520 by referencing the information of the base layer 510 may be completed.

For coding of the color image and the depth image of each layer and at each view, the SNR scalable coding unit 570 may use a coarse grain scalability (CGS) method using quantization which is a method for SNR scalability of conventional scalable video coding, a fine granular scalability (FGS) method using 2-scanning and cyclic coding based on a bit-plane method, and a medium granular scalability (MGS) method to increase a number of extraction spots of the CGS method using a prediction structure of the FGS method. Loss of information may occur during frequency-transformation and quantization of residual data, thereby causing loss of image quality of an actual video image. However, according to the embodiment of the present invention, since quantity of the residual data may be reduced, the SNR scalable coding unit 570 may perform coding for the service of various image qualities considering performance of various terminals, using the CGS method using quantization.

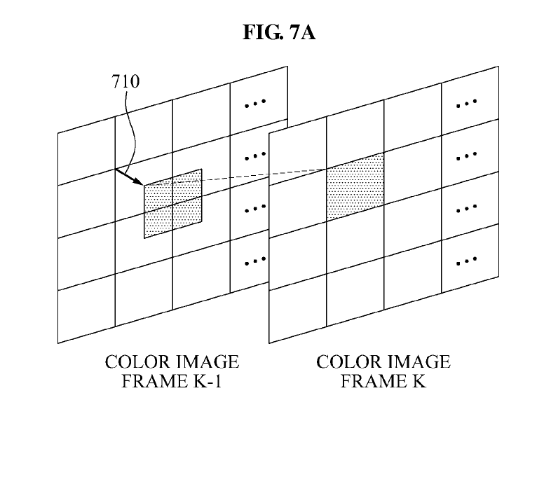

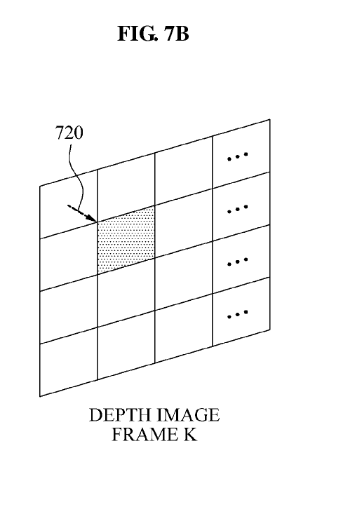

FIGS. 7A to 7C illustrate prediction of motion estimation of the depth image coding unit 550. A basic process of motion estimation of the base layer 510 of a color image shown in FIG. 7A will be described. A macro block of a current frame searches candidate blocks present within a search range of a previous frame and performs matching to find a candidate block having highest correlation with the macro block of the current frame. In addition, the depth image coding unit 550 may store location of a candidate block having a smallest sum of the absolute difference (SAD), which refers to a sum of absolute differences among pixels in the macro block of the current frame and the candidate blocks of the previous frame, using a motion vector. The macro block performs the matching with respect to all candidate blocks in the search range, thereby finding a motion vector 710. The motion vector 710 may be used as a prediction value for motion estimation of the base layer 510 of the depth image.

FIG. 7B illustrates prediction of motion estimation of the depth image. The color image and the depth image of the same view and the same time have an extremely high correlation with each other as the same motion. Therefore, the depth image coding unit 550 may predict a motion vector 720 of the depth image using the motion vector 710 of the color image. The depth image coding unit 550 may code only a difference between an actual value and a predicted value through prediction of motion estimation, thereby increasing coding efficiency. A motion vector difference between a predicted motion vector and an actual motion vector is coded and then the prediction of motion estimation is completed.

The spatial scalable coding unit 560 in the enhancement layer 520 of the depth image may use the hierarchical B structure as in the prediction structure of the spatial scalable coding unit 560 in the enhancement layer of the color image, and also use the intra-view prediction structure. Therefore, the random access performance between respective layers may be increased. Furthermore, compression efficiency may be increased by using the motion information, the texture information, the residual information of the base layer as the prediction information. The intra-view predictive coding in the enhancement layer may be completed by referencing the information of the base layer of the depth image.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A scalable video coding apparatus comprising:
a spatial scalable coding unit to perform intra-view predictive coding in base layers of a color image and a depth image and prediction in enhancement layers by referencing motion information of the base layer;
a signal-to-noise ratio (SNR) scalable coding unit to perform coding using quantization which is a method for SNR scalability of the color image; and
a motion estimation device to code the base layer of the depth image using the motion information of the base layer of the color image as prediction data.

2. The scalable video coding apparatus of claim 1, wherein the spatial scalable coding unit uses a hierarchical B structure which is an intra-view prediction structure in consideration of random access performance between respective layers.

3. The scalable video coding apparatus of claim 1, wherein the SNR scalable coding unit uses coarse-grain scalability (CGS) to reduce quantity of residual data using quantization.

4. The scalable video coding apparatus of claim 1, wherein the motion estimation device codes only a difference between an actual value and a predicted value using a motion vector of the color image.

5. A scalable video coding method for realistic broadcasting, the method comprising:
performing intra-view predictive coding in base layers of a color image and a depth image and prediction in enhancement layers by referencing motion information of the base layer;
using quantization as a method for signal-to-noise ratio (SNR) scalability of the color image; and
coding a base layer of a depth image using motion information of the base layer of the color image as prediction data.

6. The scalable video coding method of claim 5, wherein the performing comprises:
using a hierarchical B structure which is an intra-view prediction structure considering random access performance between layers.

7. The scalable video coding method of claim 5, wherein the using comprises:
using coarse-grain scalability (CGS) that reduces quantity of residual data using quantization.

8. The scalable video coding method of claim 5, wherein the coding comprises:
coding only a difference between an actual value and a predicted value using a motion vector of the color image.
